(19) United States
(12) Patent Application Publication
(10) Pub. No.: US 2021/0386055 A1
(43) Pub. Date: Dec. 16, 2021

(54) Metal-organic Framework-Assisted Cryopreservation of Red Blood-Cells

(71) Applicants: Jimin Guo, Albuquerque, NM (US); C. Jeffrey Brinker, Albuquerque, NM (US); Wei Zhu, Albuquerque, NM (US)

(72) Inventors: Jimin Guo, Albuquerque, NM (US); C. Jeffrey Brinker, Albuquerque, NM (US); Wei Zhu, Albuquerque, NM (US)

(73) Assignee: UNM Rainforest Innovations, Albuquerque, NM (US)

(21) Appl. No.: 17/309,152

(22) PCT Filed: Oct. 30, 2019
(86) PCT No.: PCT/US19/58915

§ 371 Date: Apr. 30, 2021

Related U.S. Application Data
(60) Provisional application No. 62/752,497, filed on Oct. 30, 2018.

(51) Int. Cl. A01N 1/02; B01J 20/22; B01J 20/28

(52) U.S. Cl. CPC A01N 1/0221; B01J 20/28007; B01J 20/226; A01N 1/0284

(57) ABSTRACT

Zr-based MOF NPs for cryopreservation of cells including, for example, red blood cells.

### CROSS-REFERENCE TO RELATED APPLICATIONS

The following application claims benefit of U.S. Provisional Application No. 62/752,497, filed Oct. 30, 2018, which is hereby incorporated by reference in its entirety.

### STATEMENT REGARDING GOVERNMENT SPONSORED RESEARCH

This invention was made with Government support under Grant No. DENA-0003525 awarded by the U.S. Department of Energy's National Nuclear Security Administration. The U.S. Government has certain rights in this invention.

### BACKGROUND

Cryopreservation is the process by which cells and other biological constructs are preserved by cooling them to temperatures at which all biological activity, including cell death and DNA degradation effectively stops, effectively preserving the cells an indefinite period of time. Accordingly, cryopreservation enables many exciting avenues for a wide variety of applications including, but not limited to, biological and medical treatments and research.

However, cryopreservation requires mechanisms for reducing or eliminating the ice formation and recrystallization that normally occur during the freezing process. Naturally occurring antifreeze proteins or glycoproteins (AF(G)Ps) can mitigate the deleterious effects of ice formation/recrystallization by suppressing ice formations but extracting natural AF(G)Ps from living organisms is typically an intricate, time-consuming and expensive process with low yields. Furthermore, while high levels of cell permeating cryoprotectants (CPAs) such as water-miscible organic solvents (e.g., dimethyl sulfoxide, glycerol) have been shown to reduce or eliminate ice formation, they are also increasingly toxic as concentration increases. Accordingly, solvent toxicity and the challenge of removing all traces of toxic solvents prior to transplant or transfusion is a substantial problem for clinical applicability of cryopreservation.

Accordingly, the development of hybrid nanomaterials with potent IRI activities, good biocompatibility, low-cost, and the possibility of easy mass production, is highly desirable.

### SUMMARY

The present disclosure provides novel materials and methods for cryopreservation of biological cells and constructs including, but not necessarily limited to red blood cells. In general, the application is directed towards the use of Zr-based MOF NPs for cryopreservation of red blood cells. Exemplary Zr-based MOF NPs include, but are not limited to UiO-66, UiO-66-NH2, UiO-66-OH, MOF-808, MOF801, UiO-66, MOF-804, MOF-805, MOF-806, MOF-812, MOF-802, MOF-841, DUT-67 and MOF-808.

### BRIEF DESCRIPTION OF THE DRAWINGS

FIG. 1A depicts the metal node of the UiO-66 variant of a Zr-based MOF NP of the present disclosure.

FIG. 1B depicts the crystalline structure of the UiO-66 variant.

FIG. 1C depicts the (111) plane of the UiO-66 variant.

FIG. 1D depicts the —COOH distribution on the (111) plane of the UiO-66 variant.

FIG. 2A depicts the metal node of the UiO-67 variant of a Zr-based MOF NP of the present disclosure.

FIG. 2B depicts the crystalline structure of the UiO-67 variant.

FIG. 2C depicts the (111) plane of the UiO-67 variant.

FIG. 2D depicts the —COOH distribution on the (111) plane of the UiO-67 variant.

FIG. 3A depicts the metal node of the MOF-808 variant of a Zr-based MOF NP of the present disclosure.

FIG. 3B depicts the crystalline structure of the MOF-808 variant.

FIG. 3C depicts the (111) plane of the MOF-808 variant.

FIG. 3D depicts the —COOH distribution on the (111) plane of the MOF-808 variant.

FIG. 4 shows the recovery of human RBCs cryopreserved in either the Zr-based MOF NPs of the present disclosure or HES polymer PBS dispersions at different concentrations.

FIG. 5 is an image of the MOF surface SBU densities on the (111) plane against the density of hydrogen donor groups on the MOF (111) plane.

### DETAILED DESCRIPTION

According to an embodiment the present disclosure provides novel materials and methods for cryopreservation of biological cells and constructs including, but not limited to organisms, cells, tissue, organelles, extracellular matrices, and organs. For ease of discussion, the present disclosure generally describes the cryopreservation of cells and specifically describes the cryopreservation of red blood cells. However, it should be understood that the materials and methods described herein may be similarly useful for other biological organisms and constructs including those described above.

According to a first embodiment, the present disclosure provides novel metal-organic-framework nanoparticles (MOF NPs) that modulate or inhibit the growth of ice crystals in cryopreservation applications. According to a more specific embodiment, the MOF NPs of the present disclosure are zirconium based. According to an even more specific embodiment, the present disclosure provides exemplary Zr based MOF NPs with differing pore size, surface chemistry, and framework topologies.

MOFs are periodic well-defined porous materials that are typically self-assembled by metal nodes and organic linkers, offering high control of chemical functionality, pore size, and shapeTh The MOFs disclosed herein provide precise spacing of hydrogen donor groups that both recognize and match the prism/basal plane of ice crystals, thereby inhibiting ice crystal growth. Moreover, the MOFs disclosed herein are further able to “catalyze” the melting of ice crystals.

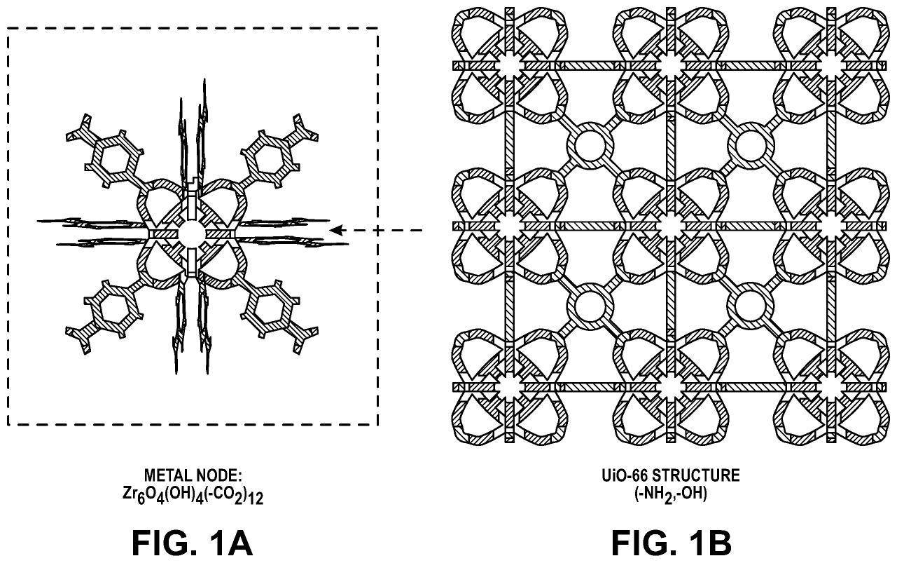

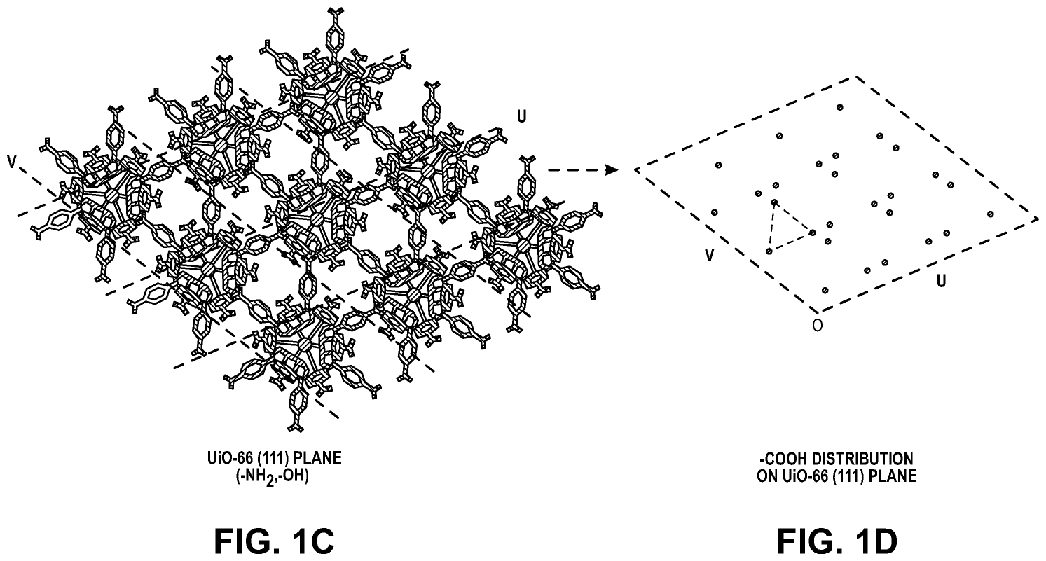

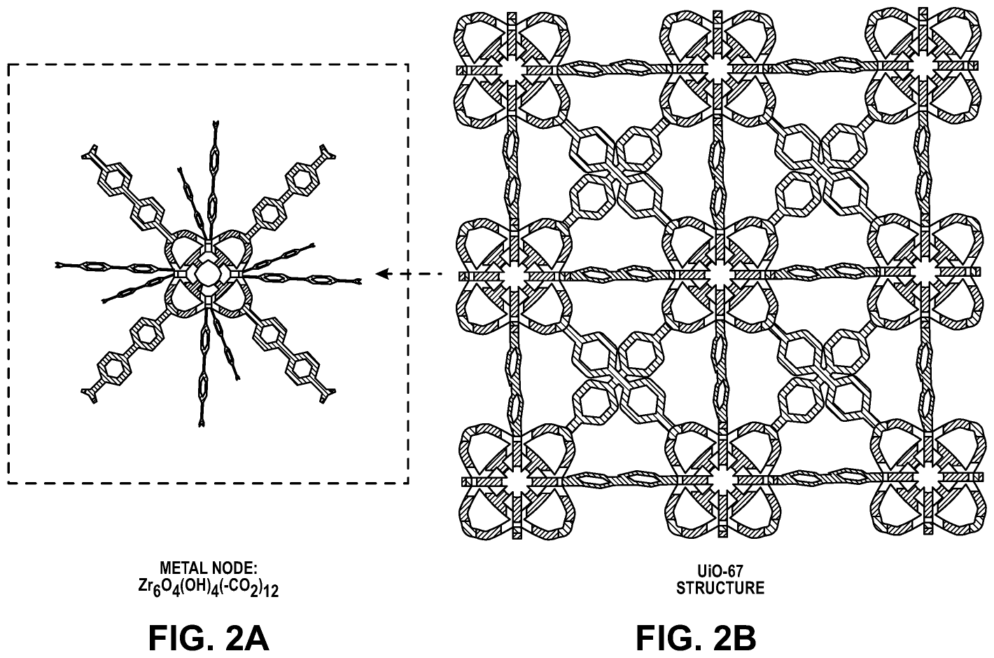

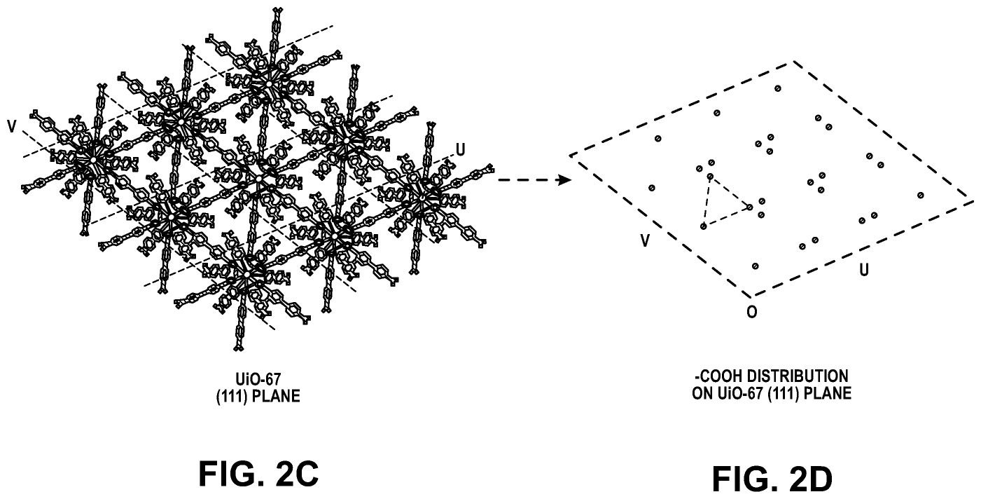

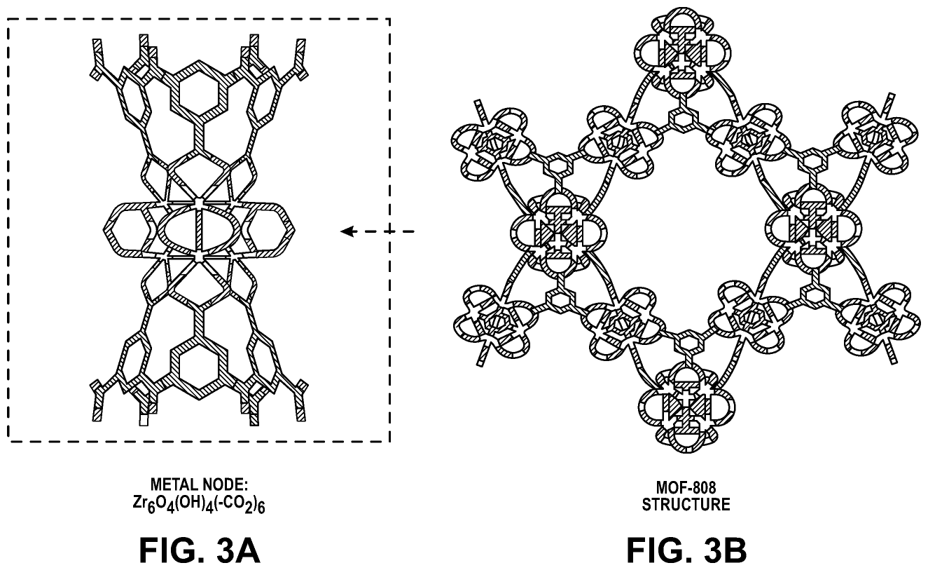

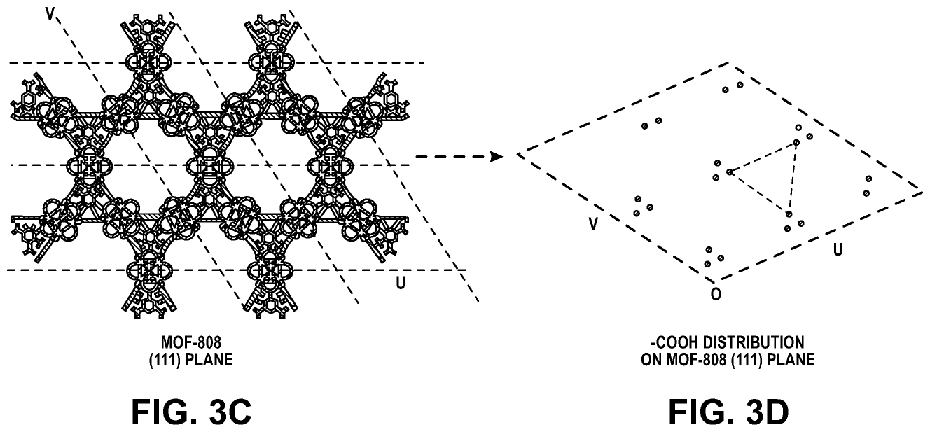

FIGS. 1-4 depict various exemplary Zr-based MOF NPs useful for cryopreservation applications. Specifically, FIGS. 1A-1D depict a Zr-based MOF NP referred to herein as UiO-66. The metal node of UiO-66 is shown in FIG. 1A. FIG. 1B shows the crystalline structure. FIG. 1C shows the (111) plane. FIG. 1D shows the related —COOH distribution on the UiO-66 (111) plane. FIGS. 2A-2D depict a Zr-based MOF NP referred to herein as UiO-67. The metal node of UiO-67 is shown in FIG. 2A. FIG. 2B shows the crystalline structure. FIG. 2C shows the (111) plane. FIG. 2D shows the related —COOH distribution on the UiO-67 (111) plane. FIGS. 3A-3D depict a Zr-based MOF NP referred to herein as MOF-808. The metal node of MOF-808 is shown in FIG. 3A. FIG. 3B shows the crystalline structure. FIG. 3C shows the MOF-808 (111) plane. FIG. 3D shows the related -COOH distribution on the MOF-808 (111) plane.

Those of skill in the art will understand that MOFs are highly designable and easily modified and techniques for designing MOFs with desired physical and chemical characteristics are well-known. Accordingly, the present disclosure contemplates a wide variety of variations to the presently disclosed embodiments and the specifically disclosed variants should be considered as non-limiting examples. For example, the Zr-based MOF NPs of the present disclosure can be modified to include various functional groups. As a specific non-limiting example, two variants of UiO-66 were formed by including —NH2 and —OH groups. These variants are referred to herein as UiO-66-NH2 and UiO-66-OH, respectively. Moreover, while the structures shown in FIG. 1 remain the same for these variants, as described in greater detail below, modification with functional groups produces different levels of ice recrystallization inhibitor (IRI) activity.

According to an embodiment, the Zr-based MOF NPs can be synthesized using techniques such as those described in Lu et al., Synthesis and Self-Assembly of Monodispersed Metal-Organic Framework Microcrystals. Chem. Asian J. 8, 69-72 (2013) and Furukawa et al., Water Adsorption in Porous Metal-Organic Frameworks and Related Materials. J. Am. Chem. Soc. 136, 4369-4381 (2014). In general, a mixed solution containing zirconium salts, an organic linker, and a modulating agent such as formic acid or acetic acid is heated for a given amount of time. The specific organic linker used will determine the specific structure of the MOF NPs.

As a specific example, UiO-66 can be synthesized by dissolving 25.78 mg ZrC14 (0.11 mmol) and 13.29 mg 1,4-benzenedicarboxylic acid (0.08 mmol) in 10 mL of DMF solution. 1.441 g acetic acid (0.024 M) is then added into the above solution. The mixed solution is placed in an oven (120° C.) for 24 h. After the reaction mixture is cooled to room temperature, the resulting NPs are subsequently washed with DMF and methanol via centrifugation redispersion cycles. Variants can be synthesized by substituting different linkers for the 1,4-benzenedicarboxylic acid. For example, UiO-66 -NH2 can synthesized by substituting 2-amino terephthalic acid for the 1,4-benzenedicarboxylic acid. UiO-66-OH can be synthesized by substituting 2,5-dihydroxyterephthalic acid and UiO-67 can be synthesized by substituting biphenyl-4,4′-dicarboxylic acid.

As another specific example, MOF-808 can be synthesized by dissolving 0.11 g H3BTC (0.50 mmol) and 0.16 g ZrOCl2.8H2O (0.50 mmol) in 40 mL of mixed DMF/formic acid solution (20 mL/20 mL). The mixed solution is then placed in an oven (100° C.) for 48 h. After the reaction mixture is cooled to room temperature, the resulting NPs are subsequently washed with DMF and methanol via centrifugation redispersion cycles.

Additional details regarding UiO-66, UiO-66-NH2, UiO-66-OH, and MOF-808 including characterization information can be found, for example, in Zhu et al., J. Am. Chem. Soc. 2019, 141, 7789-7796 (see also accompanying Supporting information) which is hereby incorporated by reference for all purposes.

Other possible Zr-based MOFs suitable for use in the presently described methods include, but are not limited to; MOF801 which is typically synthesized with ZrC14 as the Zr precursor and Fumatic acid as the linker; UiO-66 which is typically synthesized with ZrC14 as the Zr precursor and H2BDC as the linker; MOF-804 which is typically synthesized with ZrC14 as the Zr precursor and H2BDC-(OH)2 as the linker; MOF-805 which is typically synthesized with ZrC14 as the Zr precursor and H2NDC-(OH)2 as the linker; MOF-806 which is typically synthesized with ZrC14 as the Zr precursor and H2BPDC-(OH)2 as the linker; MOF-812 which is typically synthesized with ZrC14 as the Zr precursor and H4MTB as the linker; MOF-802 which is typically synthesized with ZrC14 as the Zr precursor and H2PZDC as the linker; MOF-841 which is typically synthesized with ZrC14 as the Zr precursor and H4MTB as the linker; DUT-67 which is typically synthesized with ZrC14 as the Zr precursor and H2TDC as the precursor; and MOF-808 which is typically synthesized with ZrC14 as the Zr precursor and H3BTC as the linker.

In practice, a mixture of the cells to be cryopreserved and the Zr—MOF—NPs can be frozen using well-known techniques. According to one specific example, an aqueous suspension of the cells and Zr—MOF—NPs in 1× PBS solution is rapidly frozen in liquid nitrogen and then stored (typically in liquid nitrogen). Of course, well-known slow freeze techniques may also be employed.

According to a specific embodiment, at least some of the Zr—MOF—NPs are selected from the group consisting of UiO-66, UiO-66-NH2, UiO-66-OH, and MOF-808. However, it will be understood that the present disclosure contemplates that use of a single type of MOF or combinations of different MOFs including, but not necessarily limited to, those identified in the present disclosure. Moreover, the mixture of MOFs and cells could include additional cryopreservants including, but not limited to, hydroxyethyl starch, poly(vinyl alcohol), peptides, ethylene glycol, glycerol, sucrose, and trehalose.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

All patents and publications referenced below and/or mentioned herein are indicative of the levels of skill of those skilled in the art to which the invention pertains, and each such referenced patent or publication is hereby incorporated by reference to the same extent as if it had been incorporated by reference in its entirety individually or set forth herein in its entirety. Applicants reserve the right to physically incorporate into this specification any and all materials and information from any such cited patents or publications.

### REFERENCES

a) H. Furukawa, et al., Science 2013, 341, 1230444; b) A. Bétard, et al., Chem. Rev. 2012, 112, 1055; c) S. M. Cohen, Chem. Rev. 2012, 112, 970; d) N. Stock, et al., Chem. Rev. 2012, 112, 933; e) L. J. Murray, M. Dină, J. R. Long, Chem. Soc. Rev. 2009, 38, 1294; f) J. Li, J. Sculley et al., Chem. Rev. 2012, 112, 869; g) L. Ma, et al., Chem. Soc. Rev. 2009, 38, 1248; h) O. K. Farha, et al., Acc. Chem. Res. 2010, 43, 1166; i) P. Z. Moghadam, et al., Chem. Mater., 2017, 29, 2618. a) H. Furukawa, et al., Science 2013, 341, 1230444; b) A. Bétard, et al., Chem. Rev. 2012, 112, 1055; c) S. M. Cohen, Chem. Rev. 2012, 112, 970; d) N. Stock, et al., Chem. Rev. 2012, 112, 933; e) L. J. Murray, et al., Chem. Soc. Rev. 2009, 38, 1294; f) J. Li, et al., Chem. Rev. 2012, 112, 869; g) L. Ma, et al., Chem. Soc. Rev. 2009, 38, 1248; h) O. K. Farha, et al., Acc. Chem. Res. 2010, 43, 1166; i) P. Z. Moghadam, et al., Chem. Mater., 2017, 29, 2618. j) Zhu et al., J. Am. Chem. Soc. 2019, 141, 7789-7796

### EXAMPLES

### Cryopreservation of Red Blood Cells

Cryopreservation of human RBCs was investigated using a rapid freezing protocol. Briefly, an aqueous suspension of RBC-MOF NPs in 1× phosphate-buffered saline (PBS) solution was rapidly frozen in liquid nitrogen (N₂) and then stored in liquid N₂ for two days, followed by a slow thawing process at 4° C. The thawing at 4° C. was chosen due to the maximum stress it applies to cells, offering a stringent test of the cryopreservative performance of the synthesized MOF NPs.

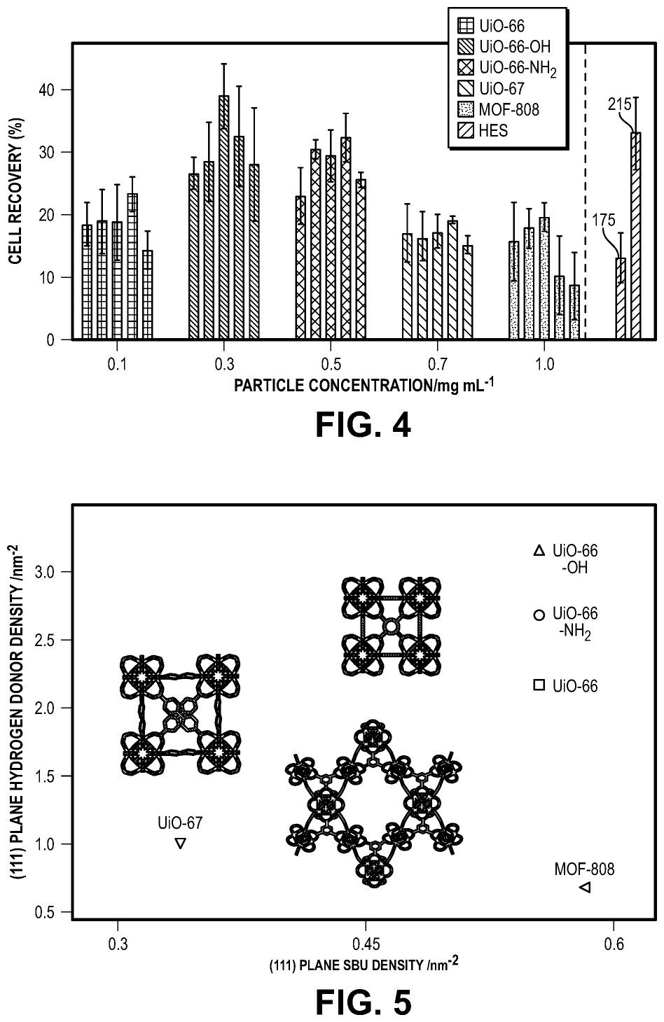

As shown in FIG. 4, for all the cases tested, the RBC recovery first increased with increasing concentration of MOF NPs and then decreased when the MOF NP concentration reached to 1.0 mg mL⁻¹. The highest cell recovery (˜40%) occurred for UiO-66-OH MOF NPs at a concentration of 0.5 mg mL⁻¹ without any organic solvents. This cell recovery level is better than that achieved by the commercial polymer, hydroxyethyl starch (HES), at high concentrations of 175 (13.2%), and 215 (32.1%) mg mL⁻¹, respectively.

FIG. 5 shows the surface SBU densities on the (111) plane against the density of hydrogen donor groups (—COOH) on MOF (111). For UiO-66-OH and UiO-66-NH₂ MOFs, the neighboring hydrogen donor groups (—OH, and —NH₂) located very close to the carboxylic groups on the top layer surface was also counted. As shown, the MOF NPs with higher densities of carboxylic groups (UiO-66-OH and UiO-66-NH₂) on the MOF outer-layer surface showed a higher cell recovery efficiency. This observation reveals the potential adsorption of MOF NPs onto the ice crystal surface through hydrogen bonding, modulating the growth of ice crystals.

What is claimed is:

1. A method for cryopreserving cells comprising;
producing a mixture of the cells to be cryopreserved and Zirconium-based metal-organic framework nanoparticles (Zr—MOF—NPs); and
subjecting the mixture to temperatures sufficient for cryopreservation.

2. The method of claims 1 wherein the cells are red blood cells.

3. The method of claim 1 wherein at least some of the Zr—MOF—NPs are selected from the group consisting of UiO-66, UiO-66-NH2, UiO-66-OH, MOF-808, MOF801, UiO-66, MOF-804, MOF-805, MOF-806, MOF-812, MOF-802, MOF-841, DUT-67 and MOF-808.

4. The method of claim 1 wherein at least some of the Zr—MOF—NPs are selected from the group consisting of UiO-66, UiO-66-NH2, UiO-66-OH, and MOF-808.

5. The method of claim 1 wherein at least some of the Zr—MOF—NPs are UiO-66.

6. The method of claim 1 wherein at least some of the Zr—MOF—NPs are UiO-66-OH.

7. The method of claim 1 wherein at least some of the Zr—MOF—NPs are UiO67.

8. The method of claim 1 wherein at least some of the Zr—MOF—NPs are MOF-808.

9. The method of claim 1 further comprising adding an additional cryopreservant to the mixture.

10. A composition of matter comprising a mixture of cells and Zr—MOF—NPs.

11. The composition of matter of claim 10 wherein the cells are red blood cells.

12. The composition of matter of claim 10 wherein at least some of the Zr—MOF—NPs are selected from the group consisting of UiO-66, UiO-66-NH2, UiO-66-OH, MOF-808, MOF801, UiO-66, MOF-804, MOF-805, MOF-806, MOF-812, MOF-802, MOF-841, DUT-67 and MOF-808.

13. The composition of matter of claim 10 wherein at least some of the Zr—MOF—NPs are selected from the group consisting of UiO-66, UiO-66-NH2, UiO-66-OH, and MOF-808.

14. The composition of matter of claim 10 wherein at least some of the Zr—MOF—NPs are UiO-66.

15. The composition of matter of claim 10 wherein at least some of the Zr—MOF—NPs are UiO-66-OH.

16. The composition of matter of claim 10 wherein at least some of the Zr—MOF—NPs are UiO67.

17. The composition of matter of claim 10 wherein at least some of the Zr—MOF—NPs are MOF-808.
